(19) United States
(12) Patent Application Publication
(10) Pub. No.: US 2002/0195241 A1
(43) Pub. Date: Dec. 26, 2002

(54) System for selective heating and cooling of the rear area of a vehicle passenger cabin

(76) Inventors: James Allen Baker, Williamsville, NY (US); Mahmoud Ghodbane, Lockport, NY (US)

Correspondence Address: PATRICK M. GRIFFIN, DELPHI TECHNOLOGIES, INC., Legal Staff, Mail Code: 480-414-420, P.O. Box 5052, Troy, MI, 48007-5052, US

(21) Appl. No.: 09/891,006

(22) Filed: Jun. 25, 2001

(51) Int. Cl. B60H 3/00; B61D 27/00; B60H 1/00; F24F 11/04; F24F 11/06

(52) U.S. Cl. 165/202; 165/42; 165/43; 165/244

(57) ABSTRACT

A system for selectively heating or cooling a vehicle's passenger cabin is provided. The system provides heating and cooling through a secondary loop heat exchanger system that includes a heat exchanger, an actuator, an air bypass and a puller fan. A desired air temperature can be obtained by controlling air drawn through the heat exchanger and the air bypass.

### TECHNICAL FIELD

This invention is directed to the selective heating and cooling of the rear area of a vehicle passenger cabin. More particularly, the present invention relates to a HVAC system that uses a single heat exchanger for heating and cooling that receives cooling fluid from a secondary loop coolant and heating fluid from a heat source such as the vehicle's engine. Selective heating and cooling of the passenger cabin is further provided. The invention replaces the typical rear evaporator and heater of traditional systems with a more economical fan/heat exchanger system. The invention provides temperature control that is independent of the amount of coolant flow to the rear area and the total airflow through the rear system. Flow control of the coolant is thereby eliminated.

### BACKGROUND OF THE INVENTION

Systems for selectively heating and cooling the rear area of a vehicle are known. Typically, the rear air conditioning portion of these systems employs a separate evaporator and refrigerant lines that are connected to the primary loop or front air conditioning system of the vehicle. Having two separate systems increases the cost of the vehicle air conditioning system because of the need for a rear evaporator, additional refrigerant lines and valves, increased refrigerant charges and additional labor costs to install the separate system. One example of a dual evaporator system is described in U.S. Pat. No. 5,910,157.

There have been attempts to eliminate the duplication of components in systems used to heat and cool the front and rear of vehicles. In U.S. Pat. No. 5,904,052, a primary refrigerant system is employed to deliver decompressed refrigerant to a brine-refrigerant heat exchanger, which cools the brine. A pump pumps the cooled brine through a front air conditioning unit and a rear air conditioning unit. The system also employs the hot coolant water of the engine to control the temperature of the air that is provided to the vehicle. There is provided a common passage portion with switching valves through which both the hot coolant water and the brine flow into the air conditioning heat exchanger. One disadvantage of the system is its complexity. The system employs a brine-refrigerant heater and the engine coolant, plus air conditioning units that are separate from the brine-refrigerant heater. Due to this arrangement, the system requires a complex array of valves and piping, to heat and cool the vehicle.

### SUMMARY OF THE INVENTION

The present invention overcomes the above problems associated with known attempts to effectively and efficiently heat and cool the rear passenger area of a vehicle. The present invention provides a single secondary loop-driven heat exchanger capable of performing both heating and cooling functions that is suitable for replacing current rear HVAC systems that include an evaporator and heater core. Bi-level operation is further enabled.

The secondary loop heat exchanger (SLHE) system of the present invention comprises a single heat exchanger for heating and cooling a particular passenger area. An organization of valves and piping enables a fluid cooled by a secondary loop (i.e., air conditioning system) to flow through the heat exchanger when cooling is required. The SLHE system also enables a heated fluid, which is preferably engine coolant, to flow through the heat exchanger when heating is selected. The system also includes a puller fan that is located downstream of the heat exchanger that pulls passenger cabin air through the heat exchanger and returns it to the cabin. The system further includes an actuator-controlled air inlet (e.g., a collar, valve, door, etc.) that is situated between the puller fan and the heat exchanger to provide an incoming air bypass around the heat exchanger. By modulating the air bypass, temperature control can be provided without changing the airflow through the system. The system can be adapted for either a single output or multiple outputs, including for example, bi-level operation to passenger head and foot areas.

The SLHE system combines a puller fan with a heat exchanger and an actuator that controls an air bypass circuit. The puller fan draws air from the passenger cabin and through the puller fan to return it to the passenger cabin. As the air is pulled from the cabin, it is drawn across the heat exchanger or through the air bypass, or may be drawn through both air flow channels, according to the air temperature desired. The system of the present invention may further optionally include a ducting arrangement that provides multi-level operation to control warmer or cooler ducted air flow to upper and lower regions of the rear cabin area by selective introduction of bypass cabin air to the selected air duct.

The present invention provides a low cost secondary loop heating and cooling system capable of independent control of air flow (via fan speed control) and control of temperature (via heat exchanger capacity control) using the air bypass to allow selected portions of incoming cabin air to bypass the heat exchanger. The inclusion of the present air bypass circuit to control air temperature eliminates the need for the conventionally used flow control systems for HVAC systems known in the art. Moreover, the use of a puller fan to draw air linearly enables the use of less expensive fans that are smaller, quieter, use less energy and require less total packaging space in the vehicle.

### BRIEF DESCRIPTION OF THE DRAWINGS

FIG. 1 is a schematic view of a preferred embodiment of the present invention for single output operation.

FIG. 2 is a schematic view of a preferred embodiment of the present invention for bi-level operation.

FIG. 3 is a schematic view of the present invention used in conjunction with a typical secondary loop system.

FIG. 4 is a schematic view of the present invention used in conjunction with an alternative secondary loop system.

### DETAILED DESCRIPTION OF THE PREFERRED EMBODIMENT

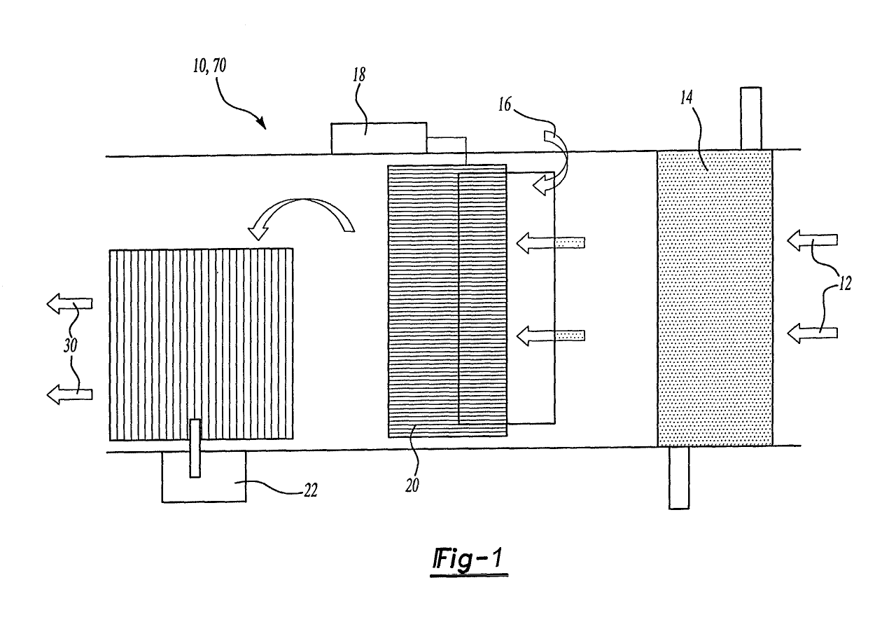

Referring to FIG. 1, the secondary loop heat exchanger (SLHE) system 10 (also referred to herein as 70) of the present invention includes a heat exchanger 14, an actuator 18 that controls an air bypass 20, and a puller fan 22 in which the air bypass 20 is preferably located between heat exchanger 14 and puller fan 22 to selectively draw air 12, 16 from the passenger cabin either across heat exchanger 14 or through air bypass 20, or both, to provide a desired level of cooling or heating. Actuator 18 is situated upstream from puller fan 22 and downstream from heat exchanger 14. Actuator 18 controls the amount of air 12, 16 drawn from heat exchanger 14 and air bypass 20 so that all of the output air 30 may be drawn across heat exchanger 14 or all may be drawn from air bypass 20, or a selected portion of air 12, 16 may be drawn from each of heat exchanger 14 and air bypass 20. Actuator 18 is remotely controlled by a selector (not shown) located within the passenger cabin. Actuator 18 may be of any type known in the art such as, for example, electrical, mechanical, pneumatic or manual. Passenger cabin temperature can thereby be controlled with actuator 18 to provide airflow completely from air 12 drawn across heat exchanger 14, completely from air 16 drawn from air bypass 20, or selectively from both heat exchanger 14 and air bypass 20.

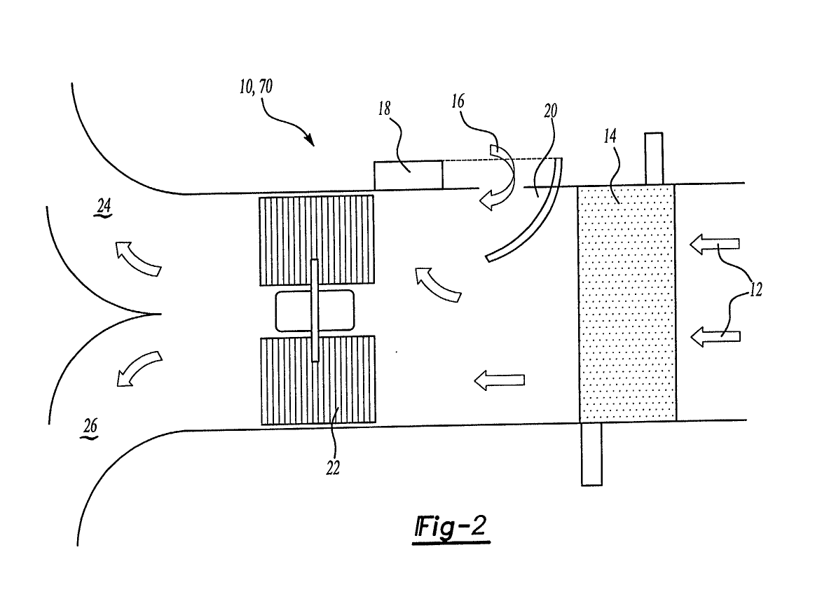

Referring to FIG. 2, the present invention may be optionally adapted to provide bi-level (or multi-level) airflow to upper and lower regions of the passenger cabin. In such an embodiment, additional ducting 24, 26 is provided within system 10 (and 70) to enable air temperature control for upper and lower regions of the rear cabin by selective introduction of air from air bypass 20.

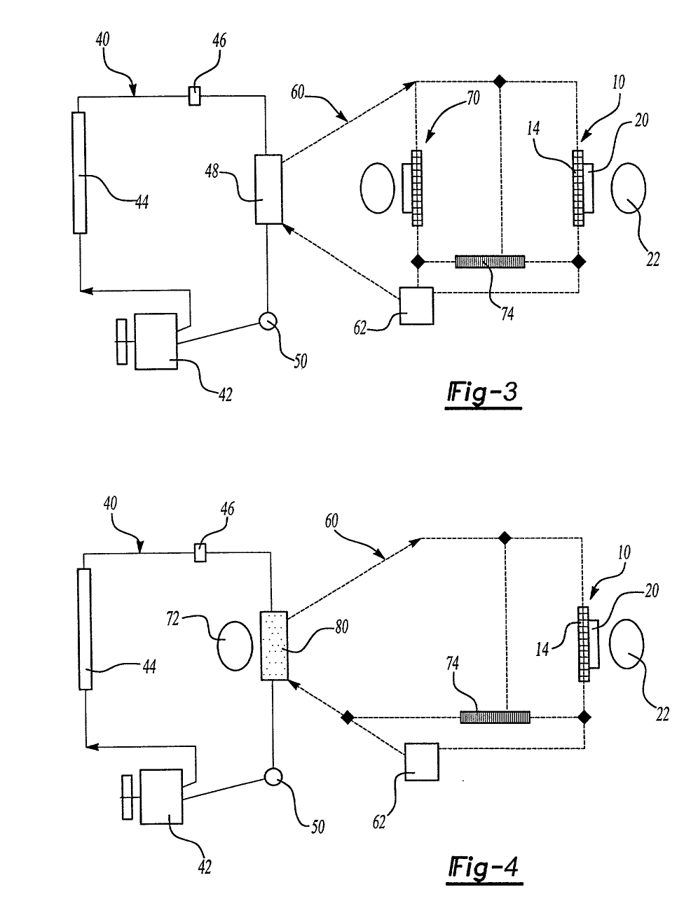

The SLHE system of the present invention as contemplated for use in vehicle HVAC systems is schematically depicted in FIGS. 3 and 4. Referring to FIG. 3, the present invention is incorporated into a typical vehicle HVAC system that includes a primary refrigeration loop 40, a heated fluid source 74 such as engine coolant, a secondary coolant loop 60 and a pump/reservoir 62 that includes a heat transfer fluid such as a water-glycol solution. The HVAC system provides the selected heating, cooling and ventilation. When heating is selected, the engine (not shown) serves as the heated fluid source 74 and pumps a heated fluid (e.g., engine coolant) into and through the secondary coolant loop 60 to pass through one or both of SLHE systems 10, 70. Thus, rear heating only may be selected in which the heated fluid passes through only SLHE system 10. After passing through the selected SLHE systems 10, 70, the heated fluid returns to the heated fluid source 74. In either heating mode, the heated fluid does not pass through pump/reservoir 62.

When cooling is selected, a refrigerant is circulated through the primary loop 40 and a heat transfer fluid from pump/reservoir 62 is circulated through the secondary loop 60. By heat transfer, thermal energy is passed from the refrigerant to the heat transfer fluid through heat exchanger 48. The cooled heat transfer fluid is circulated by pump/reservoir 62 to pass through SLHE systems 10, 70. After passing through SLHE systems 10, 70, the cooled fluid returns to the pump/reservoir 62. When ventilation is selected, air is either re-circulated within the cabin areas or drawn from an external source into the cabin.

As illustrated in FIG. 3, the primary loop 40 includes a compressor 42 that delivers compressed refrigerant to the condenser 44. The refrigerant then travels through an expansion device 46, through a heat exchanger 48 into an accumulator-dehydrator 50 and back to the compressor 42. In the HVAC system shown, the heat exchanger 48 is a chiller. As noted above, the secondary loop 60 includes a pump/reservoir 62 which pumps a heat transfer fluid, such as a water-glycol solution, around the secondary loop 60. The heat transfer fluid is pumped through the heat exchanger/chiller 48 to SLHE systems 10, 70 and through their respective heat exchangers before being returned to the pump/reservoir 62. As shown in FIG. 3, SLHE system 10 provides rear area cooling and SLHE system 70 provides front area cooling.

The present invention may be advantageously used in any type of vehicle HVAC system that includes a secondary loop. Referring to FIG. 4, an alternative vehicle HVAC system is shown in which the present invention may be incorporated. As shown, a 3-fluid heat exchanger 80 combines the functions of heat exchanger 48 and front area SLHE system 70 to provide front cabin area heating and cooling. A representative 3-fluid heat exchanger is described in U.S. Pat. No. 5,898,995, incorporated herein by reference.

In cooling mode, the heat transfer fluid is pumped from pump/reservoir 62 to heat exchanger 80 and through secondary loop 60. The heat transfer fluid is chilled as it passes through heat exchanger 80 by the refrigerant primary loop 40. The cooled heat transfer fluid in the secondary loop 60 is pumped to SLHE system 10 to provide rear cooling and is then returned to the pump/reservoir 62.

When heating is selected, heated fluid source 74 provides a heated fluid (e.g., engine coolant fluid) which is pumped into and through the secondary loop 60. The heated fluid flows through heat exchanger 80 and/or SLHE system 10 and is then returned to heated fluid source 74. In this mode, the heated fluid does not pass through pump/reservoir 62.

With reference to FIGS. 3 and 4, while both front and rear heating is depicted, rear heating is optional. In those instances in which only rear cooling is desired, the heated fluid is returned to heated fluid source 74 after passing through heater exchanger 80 or SLHE system 70.

The invention has been described in an illustrative manner, and it is to be understood that the terminology, which has been used, is intended to be in the nature of words of description rather than of limitation.

Obviously, many modifications and variations of the present invention are possible in light of the above teachings. It is therefore to be understood that within the scope of the appended claims, wherein reference numerals are merely for convenience and are not to be in any way limiting, the invention may be practiced otherwise and as specifically described.

What is claimed is:

1. A secondary loop heat exchanger system for use in a vehicle HVAC system to provide selective heating and cooling comprising, a heat exchanger (14), an actuator (18), an air bypass (20) and a puller fan (22), wherein said actuator (18) controls entry of air through said air bypass (20) and said air bypass (20) is located downstream from said heat exchanger (14) and upstream from said puller fan (22).

2. A secondary loop heat exchanger system of claim 1 further comprising ducting (24, 26) for bi-level operation.

3. In a vehicle HVAC system that comprises a primary refrigeration loop (40), a secondary coolant loop (60), a pump/reservoir (62) and a heated fluid source (74) that are physically and thermally connected together to provide selective heating and cooling to the vehicle's passenger cabin areas: at least one secondary loop heat exchanger system that is integrated into said secondary coolant loop (60) in which each of said secondary loop heat exchanger systems comprise, a heat exchanger (14), an actuator (18), an air bypass (20) and a puller fan (22), wherein said actuator (18) controls air entry through said air bypass (20) and said air bypass (20) is located downstream from said heat exchanger (14) and upstream from said puller fan (22).

4. In a vehicle HVAC system of claim 3, wherein said at least one secondary loop heat exchanger system includes at least one a secondary loop heat exchanger system (10) for cooling and heating a rear vehicle area and at least one secondary heat exchanger system (70) for cooling and heating a front vehicle area.

5. In a vehicle HVAC system of claim 3, wherein said at least one secondary loop heat exchanger system further comprises ducting (24, 26) for bi-level operation.

6. A method of providing selective heating and cooling to a vehicle's passenger cabin using a vehicle HVAC system that comprises a primary refrigeration loop (40), a secondary coolant loop (60), a pump/reservoir (62) and a heated fluid source (74) that are connected physically and thermally connected together and wherein said secondary coolant loop (60) includes at least one secondary loop heat exchanger system that comprises a heat exchanger (14), an actuator (18), an air bypass (20) and a puller fan (22), whereupon selection of cooling or heating, a cooled heat transfer fluid or heated fluid is passed through said secondary loop (60) and into and through said heat exchanger (14) as air is drawn across said heat exchanger (14) or said air bypass (20) or both to provide selective heating or cooling to said vehicle's passenger cabin.

7. A method of claim 6 wherein said at least one secondary loop heat exchanger system comprises one secondary heat exchanger system (10) that provides selective heating and cooling for a rear passenger cabin area and one secondary loop heat exchanger system (70) that provides selective heating and cooling to a front passenger cabin area.

8. A method of claim 6 wherein said at least one secondary loop heat exchanger system consists of one secondary heat exchanger system (10) that provides selective heating and cooling to only a rear passenger cabin area.

9. A method of claim 6 wherein said at least one secondary loop heat exchanger system further comprises ducting (24, 26) that provides bi-level operation of said selective heating and cooling.
